(19) United States
(12) Patent Application Publication
(10) Pub. No.: US 2013/0143186 A1
(43) Pub. Date: Jun. 6, 2013

(54) METHOD FOR TEACHING SOCIAL BEHAVIOR

(71) Applicant: Lynn H. Singletary, Baton Rouge, LA (US)

(72) Inventor: Lynn H. Singletary, Baton Rouge, LA (US)

(21) Appl. No.: 13/817,507

(22) PCT Filed: Nov. 4, 2011
(86) PCT No.: PCT/US11/59306

§ 371 Date: Feb. 18, 2013

Related U.S. Application Data
(60) Provisional application No. 61/410,271, filed on Nov. 4, 2010.

(51) Int. Cl. G09B 19/00

(52) U.S. Cl. CPC G09B 19/00
USPC 434/236

(57) ABSTRACT

A method for teaching social behavior to students comprises the steps of identifying rules of conduct, establishing positive consequences for obeying the rules of conduct and establishing negative consequences for disobeying the rules of conduct, teaching the students the rules of conduct and the consequences for obeying and disobeying the rules of conduct, tracking and recording on a periodic basis the conduct of students in disobeying the rules of conduct, establishing a grading scale and assigning to the students a grade based on their conduct and the grading scale, monitoring over time the changes to the grade, conducting behavior class for the students, and re-evaluating the grading scale based on the grade made by the students over time.

### BACKGROUND OF THE INVENTION

1. Field of the Invention

This invention relates in general to a method for teaching social behavior, and more particularly to a method for teaching social behavior to students in a classroom environment.

2. Prior Art

Schools today are undergoing extraordinary changes in terms of teacher quality and school accountability, reflecting the importance of academic achievement for successful participation in contemporary society. Federal legislation, such as the No Child Left Behind Act (NCLB) and Individuals with Disabilities Education Improvement Act (DEJA), reflect the importance of academic achievement in school. NCLB places the responsibility on teachers and administrators to ensure that students make adequate academic progress. It is recognized in the teaching profession that good behavior and discipline of students are essential to academic learning. It is also recognized that bad behavior and lack of discipline impair the quality of teaching and learning. Instrumental in obtaining good behavior and discipline of students is the teacher who is accountable for teaching, monitoring, assessing, and improving student academic behavior, as reflected in test scores. However, effective classroom management requires a depth of knowledge and skill sets to implement. In many cases teachers do not receive adequate training and support to implement data-based learning plans.

Early social behavior programs were designed to react to bad behavior and lack of discipline and to utilize aversive types of management strategies. The current social behavior programs are designed to be positive, proactive and incorporate preventive strategies into school wide discipline plans. Such programs included a tiered service delivery model that utilizes early screening and universal evidence-based instruction that depends on baseline assessment of present skills with frequent monitoring that allows for adjustments and which develops data to identify students that would benefit from increasingly intensive interventions.

Despite the research and program testing there still exists a need for universal or Tier I strategies for teaching students social behavior that is efficient and effective, and is one that teachers can be easily trained to administer in the classroom environment.

### OBJECTS AND SUMMARY OF THE INVENTION

Therefore, one object of this invention is to provide a universal method for teaching students social behavior in a classroom environment.

Another object of this invention is to provide a universal method for teaching students social behavior in a classroom environment that teachers can be easily trained to administer.

Still another object of this invention is to provide a universal method for teaching students social behavior in a classroom environment that allows teachers to record data, such as with a handheld computer, with as little impact on classroom instruction as possible and to minimize time spent with the administrative aspects of the method.

Other objects and advantages of this invention shall become apparent from the ensuing descriptions of the invention.

Accordingly, this invention in one embodiment comprises a universal method for teaching students social behavior in a general classroom environment that provides a framework for teachers to teach and monitor class wide social behavior that utilizes behavior classes and rules. There are eight basic steps of the method: (1) establishing the rules of conduct, (2) establishing consequences for obeying and disobeying the rules of conduct, (3) establishing a daily tracking system of a student disobeying the rules of conduct, (4) establishing a grading scale of a student's social behavior based on the information gathered from the daily tracking system, (5) utilization of an initial behavior class to explain the social behavior training, (6) monitoring over time a student's progress in learning the established rules of conduct, (7) changing the grading scale once a predetermined level of progress has been achieved or once a predetermined time period of training has been concluded, and (8) ongoing class training of the pro-social behavior.

### BRIEF DESCRIPTION OF THE DRAWINGS

The accompanying drawings illustrate a preferred embodiment of this invention. However, it is to be understood that this embodiment is not intended to be exhaustive, nor limiting of the invention. It is but one example of the method of teaching social behavior.

FIG. 1 is a graph of the total number of rules of conduct violations by a class over a two week period.

FIG. 2 is a graph of the total number of students in a class that have achieved an “A” grade over a two week period.

### PREFERRED EMBODIMENTS OF THE INVENTION

It has been recognized that there are three major components to effective teaching: instruction of academic learning, establishing and maintaining routines and procedures, and general classroom management or instruction of social behavior. This invention is directed to a method for training students in pro-social behavior that will facilitate better classroom management and, in turn, allowing for providing better academic instructions and implementation of routines and procedures during the teaching process.

One of the unique aspects of this invention is that it is a universal program intended for use in the general classroom. It is comprised of eight steps that have been systematically integrated for teacher implementation across the school year. The first steps in this method are establishing specific rules of conduct, establishing specific consequences for obeying or disobeying the rules of conduct, establishing a daily tracking system of non-compliance with the rules of conduct, and establishing a grading scale to measure the level of non-compliance with the rules of conduct. With these matters established the next step is to conduct an initial class to explain the training program to the students, including how they will be graded. Upon completion of the initial class a teacher will begin to monitor over time the behavior of the students and record the instances that one or more of the rules of conduct have not been obeyed. After a student or classroom has achieved a pre-determined level of proficiency in obeying the rules of conduct, the grading scale is modified to require a higher level of proficiency to achieve the same grade. Alternatively, the grading scale can be modified after a predetermined period of time of monitoring has been achieved. During the monitoring period continual class instruction is conducted and students receive the predetermined consequences of obeying or disobeying the rules of conduct.

1. Establishing the Rules of Conduct. Any rule of conduct that is used in this method must have two characteristics: it must be easily observable by the teacher in the classroom environment and it must be readily measurable. The rule should also be one that is easily understood by the students. In addition, the rules of conduct should be selected to achieve one or more of the following objectives: order in the classroom, compliance with teacher instructions, safety of all students, respect of the other students and the teacher, and acceptable social behavior. It has been found that the following four rules of conduct have the two desired characteristics, are easily understood by students and will together achieve all of the desired objectives:
1. student must follow the teacher's direction;
2. student must keep his/her hands, feet and objects to himself/herself;
3. student must raise his/her hand to get the teacher's attention; and
4. student must remain in an assigned area with appropriate behavior.

Depending on the classroom situation, it may be desirable to also include other rules of conduct that will be monitored. For example, if the teacher observes a particular behavior problem (e.g., students making unkind remarks about other students), then this could be added to the rules of conduct. However, the number of rules of conduct should be minimized so not to make monitoring or recording of the instances of disobeying a rule of conduct substantially distract from the teacher providing academic teaching or maintaining set classroom routines and procedures. It has been found that utilization of these rules in the method will result in teaching clear, unambiguous, and explicit behaviors that increase time available for teaching a subject matter as well as maintain positive social interactions among the students in the classroom.

Table 1 below provides a summary of the purpose or purposes that each of the four preferred rules is designed to achieve.

TABLE I
OBJECTIVES TO BE ACHIEVED BY EACH OF THE RULES OF
CONDUCT

| | order in | | safety | respect of | accept- |
|---|---|---|---|---|---|
| | the | compliance | of | the other | able |
| RULES OF | class- | with teacher | all | students and | social |
| CONDUCT | room | instructions | students | teacher | behavior |
| student must | YES | YES | | | |
| follow the | | | | | |
| teacher's | | | | | |
| direction | | | | | |
| student must | | | YES | YES | YES |
| keep his/her | | | | | |
| hands, feet and | | | | | |
| objects to | | | | | |
| himself/herself | | | | | |
| student must | YES | | | YES | |
| raise his/her | | | | | |
| hand to get the | | | | | |
| teacher's | | | | | |
| attention | | | | | |
| Student must | YES | | YES | | |
| remain in an | | | | | |
| assigned area | | | | | |
| with | | | | | |
| appropriate | | | | | |
| behavior | | | | | |

Table II below provides for each rule of conduct the specific acceptable behavior that a student is to be trained to perform.

TABLE II
EXAMPLES OF ACCEPTABLE BEHAVIOR FOR EACH RULE OF
CONDUCT THAT IS TO BE TAUGHT TO STUDENTS

| | | | | student must |
|---|---|---|---|---|
| | | student must | student must | remain in an |
| | student must | keep his/her | raise his/her | assigned area |
| | follow the | hands, feet and | hand to get | with |
| RULES OF | teacher's | objects to | the teacher's | appropriate |
| CONDUCT | direction | himself/herself | attention | behavior |
| ACCEPTABLE | As the teacher | Keep hands on | Raise your | Sit upright-with |
| BEHAVIOR | talks or give | desk, in your | hand and stay | straight back in |
| EVENTS OF | directions, stay | personal space, | silent while | chair and feet flat |
| OBEYING | silent and still | and on your | continuing to | on floor with all |
| RULES OF | and look | school materials | work on | four chair legs on |
| CONDUCT | directly at the | unless given | another page or | the floor; |
| | teacher; | permission to do | problem or | Stay in the area |
| | Begin the task | otherwise; | wait quietly; | assigned by your |
| | when teacher | Keep feet on the | Raise your | teacher; |
| | tells you to | floor under your | arm/hand in | Walk with one |
| | begin within 3- | desk and in your | the air-full | foot in front of |
| | 5 seconds; | assigned area; | arm extension- | the other in a |
| | Raise your | Keep your desk | and wait | slow to moderate |
| | hand and ask | and area neat | silently for the | pace inside |
| | questions if | and organized | teacher to call | classroom/school |
| | you do not | with only your | on you; | |
| | understand the | school materials | With teacher | |
| | directions or | | permission, | |
| | you have a | | walk to teacher | |
| | question | | and ask your | |
| | | | question | |

Table III below provides for each rule of conduct examples of disobeying behavior that a teacher will be monitoring and recording.

TABLE III
EXAMPLES OF MEASURABLE AND OBSERVABLE EVENTS OF
DISOBEYING RULES OF CONDUCT

| | | | | student must |
|---|---|---|---|---|
| | | student must | student must | remain in an |
| | student must | keep his/her | raise his/her | assigned area |
| | follow the | hands, feet and | hand to get the | with |
| RULES OF | teacher's | objects to | teacher's | appropriate |
| CONDUCT | direction | himself/herself | attention | behavior |
| MEASURABLE | does not begin | touching others; | talking out; | bottom out of |
| AND | task within 3-5 | grabbing; | talking to | seat; standing |
| OBSERVABLE | seconds; any | kicking; | peers; yelling | by desk; |
| EVENTS OF | diversion from | throwing; | out; making | walking or |
| DISOBEYING | on task; looks | breaking objects; | noises; | wandering |
| RULES OF | away from | fighting | derogatory | about; leaving |
| CONDUCT | task; fidgets | | comments to | center area; |
| | with materials | | others; talking | leaving |
| | or clothes | | back to teacher; | classroom; |
| | | | cursing | running or |
| | | | | skipping; head |
| | | | | on desk; |
| | | | | slumped down |
| | | | | in chair |

2. Establishing Consequences. Positive reinforcement is critical to the learning process. When students engage in appropriate classroom behavior, the provision of positive reinforcement will either increase or maintain appropriate behavior. Reinforcement should be delivered frequently and focus on student accomplishments. The teacher should use different types of reinforcing (e.g., praise, edible, tangible, social, etc.) provided at fixed time periods and randomly as appropriate behavior is observed.

To increase appropriate behavior in the classroom, it is preferred to focus on the positive. When appropriate behavior is observed, the provision of a high five, a smile, a thumbs up or other types of incentives such as fun activities (e.g., class game of soccer, free or play time), tangibles (i.e., trinkets such as school supplies, toys, coupons), and edible items (i.e., candy, popcorn, juice, etc.) can be used to reinforce or maintain or strengthen the positive behavior. Providing students with a treasure chest or bank of choices for appropriate behavior may increase their motivation and encourage appropriate behavior.

The method of this invention teaches students to rule follow; however, when students violate a rule in the classroom, they earn a demerit which may be recorded as a checkmark or other symbol. The absence of a demerit is equal to rule following. When students rule follow, they earn good grades and extra incentives delivered daily and weekly.

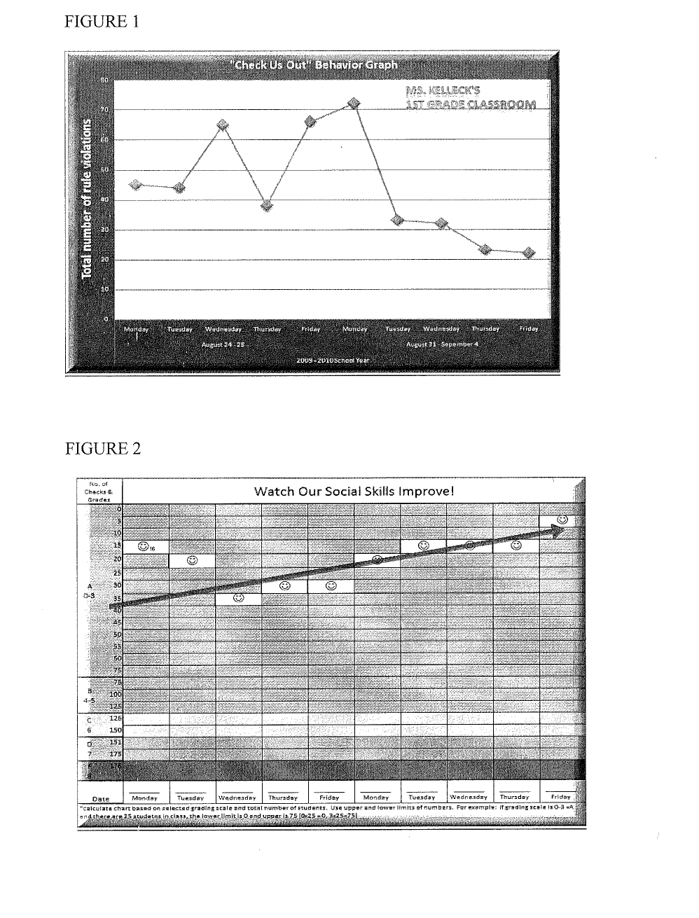

A class wide plan that promotes overall class behavior may be reinforcing for the collective class. Posting an enlarged line graph such as illustrated in FIG. 1 in a visible location that is titled “Check Us Out,” or similarly titled, will keep the students focused on increasing rule following behavior. It is preferred that this poster be updated every day by adding the class total number of violations to the chart at the end of the day. The goal is to decrease rule violations over time. It is also important to provide feedback about group behavior. For example, if as a group, there is one less check than the day before, all students may earn a “thumbs up” sticker, or coupon to be used at the school store or some other type reward. Most students like seeing the downward slope of the line which means they are meeting their goal and engaging in more appropriate behavior. Alternatively, a chart such as illustrated in FIG. 2 that focuses on an upward data trend which means students are making fewer mistakes and working toward the “A” grading range could be posted.

In addition to smiling at students and providing verbal and/or labeled praise, determining a schedule of reinforcement will promote continuous appropriate behavior in most all students. The first step is generating precise rules that describe how and when reinforcement will be presented. The rules should include the number of responses required to earn the reinforcing at the time the reinforcing will be delivered. Deciding on a routine time or fixed interval schedule (i.e., every hours, 2 hours, twice daily, end of day, end of week) to deliver the positive reinforcement ensures that students will receive what they have earned. In choosing a schedule of reinforcement for the whole class, it is necessary to consider rates of inappropriate behavior. Classes that engage in inappropriate behaviors at a high frequency (e.g., 8-15 reprimands per hour) may benefit from a richer schedule (i.e., every hour, every 2 hours, or by activity). In order to raise expectations, determine short and long term goals. Short term goals consist of daily and/or weekly and long term may be monthly and/or every grading cycle.

Students engaging in inappropriate classroom behavior (i.e., rule violating) should receive extra training and also earn a negative consequence or penalty such as a demerit. This mark serves as a reminder to listen to the teachers. The more demerits received, the lower the conduct grade. Students should know the classroom expectations and what they will earn when they engage appropriately and inappropriately.

The way classroom expectations are designed (i.e., explicitly taught, observable, and measurable) allows for an uncomplicated process for delivering the negative consequences as the inappropriate behavior is occurring or after its occurrence. The inappropriate behavior must be addressed and tracked. Each instance should be observed and counted (e.g., tally marks, checkmarks, movement of a behavior marker on poster, etc.) How this type of behavior is addressed ranges from least intrusive (e.g., redirection) to most (e.g., lower conduct grade, missing fun Friday, parental contact or office referral).

More importantly, students need ongoing training and support. Negative or reductive consequences should be used with care. The majority of students having difficulty engaging in the expected behaviors benefit more from training, support, and practice than time out or office referrals. This is a universal plan; therefore, the data from the plan should be analyzed and interventions should be provided to students as needed.

3. Tracking System. The step in the method includes the documentation of instances of following and violating classroom rules. Tracking is accomplished with either a teacher marking a paper tracking chart or entering a violation on a computer, preferably a handheld computer. When a student rule violates, for example, the teacher taps the handheld screen or places a check on the paper tracking chart which is a permanent record of child behavior. The absence of checks during a time period means appropriate rule following was observed. The record being created includes identifying information such as student names, the rules, and class sessions. For example, a teacher may determine it is necessary to reinforce rule following each class. Therefore, the record would include each class. At the end of each class, the teacher provides students with the earned reinforcement and then starts over with the next class. This continues until the end of the day. Student's daily grade is based on the number of rule violations they earned across the day.

Teaching students to self-monitor and ultimately learn behavioral self-control is the end goal. As the teacher “reminds” the student of the rule violation and provides the earned consequences, most students over time will learn not to rule violate. Students should have a form of the tracking system within their control (i.e., student monitoring card on their desk, behavior log, behavior notebook, etc.). For example, during the beginning stages of learning, when a student rule violates, the teacher can walk to the student's desk, tell them the right thing to do next time and place the checkmark on the card. With guidance from the teacher, the student can learn to keep track of their own rule following behavior. During different times of the day, the teacher should make sure that students are accurately placing checks on their cards. Both the teacher record and student conduct cards are data collection tools for gathering rule following behavior and isolating problem behaviors that occur at different times of the school day. If desired, other special marks (such as “”) can be recorded reflecting positive social behavior by a student.

The following provides an example of a student conduct card.

Student Name ______ Date ______

| | | Rule 2: | Rule 3: | Rule 4: | |
|---|---|---|---|---|---|
| | Rule 1: | Keep | Raise your | Stay in | |
| | Follow | hands feet | hand when | your | |
| | Teachers | & objects | you need | assigned | |
| Time periods | Direction | to self | assistance | area | |
| 8:30-10:00 | | | | | [symbol] |
| Reading Block | | | | | |
| 10:00-11:30 | | | | √ | 1 |
| Science/SS | | | | | |
| 11:30-1:00 | | | | | [symbol] |
| Lunch, Recess, | | | | | |
| Spelling, | | | | | |
| Computers | | | | | |
| 1:00-2:30 | | | | | [symbol] |
| Math | | | | | |
| 2:30-3:30 | | √ √ | | | 2 |
| SS, Art, end of | | | | | |
| day routine | | | | | |
| Total number | 0 | 2 | 0 | 1 | 3 |
| of rule | | | | | |
| violations | | | | | |

| | |
|---|---|
| Parent | A |
| Signature | |

Grading Scale. Once the classroom expectations are clearly defined and described, it is necessary to define the outcome that students are expected to accomplish. Developing a rubric keeps grading objective and less judgmental. This can be achieved by working backward and determining criteria or performance levels that students should be able to demonstrate. This includes levels ranging from the highest performance or “A” or “Outstanding” behavior to the lowest performance or “F” or “Yikes” behavior. Each performance level or anchor should be observable and clearly understood by all students. Performance anchors should be assigned and have both qualitative and quantitative descriptions.

Most students are rule followers and learn fairly quickly to listen to the teacher. All students should receive praise and corrective feedback often. To increase or strengthen rule following and appropriate social skills, it is best to reinforce the appropriate behavior as soon as it occurs. During the initial class training it is important to use verbal praise, thumbs up, and happy eye contact as often as possible. As student behavior becomes more appropriate and fewer mistakes are made, the grading scale is changed. For example, when 85-90% of students are making an A or B in conduct for a period of time (i.e., 1 grading cycle or ½ of the grading cycle), it is appropriate to increase your behavior expectations. Instead of reinforcing 0-3 mistakes during a time period, only students with 0-2 mistakes may earn a sticker.

Right from the start, everyone should have the opportunity to receive reinforcement. Therefore, it is important that students know how to earn both reinforcement and penalties. During the teaching process, keep in mind that some students may have difficulty maintaining “A” or “Super Star” behavior in the beginning, but with practice and feedback, an increase in rule following behavior should be observed. To plan for the school year, begin by dividing the school year into manageable units. First determine a daily reinforcement schedule such as every hour or by activity such as reading block, math and science, or beginning, middle, and end of day. The initial schedule should include more frequent periods of reinforcement (i.e., a richer schedule) and as students become more proficient, the times between reinforcement lengthens. In other words, it should be “easier” in the beginning to earn reinforcement and progressively become more difficult to earn an A.

Some teachers teach the same students all day and some teach many students. There are two important items to consider when determining a schedule of reinforcement. First, determine what “A” or “Super Star” behavior looks like (e.g., 0-3 mistakes or rule violations for the day or time period). Continue to determine the criteria for each letter grade (i.e., A, B, C, D, or F) or label (e.g., Super Star, Star, Shiny Good, Keep Practicing, etc.). Second, determine when you will provide reinforcement for “A” behavior (e.g., at the end of each hour or class period, after each subject or activity, every two hours, ½ day, at the end of the day). The key is to determine a fixed time in which students can expect to receive feedback (e.g., thumbs up, sticker, candy, verbal praise, corrective feedback, etc.) about their behavior.

“Fixing” or establishing a set time is helpful for the teacher and the students. Most teachers get very involved in teaching and may “forget” to stop and provide reinforcement. Usually teachers do stop to correct or reprimand, but often forget to praise. This could upset the positive balance in the classroom and maladaptive behaviors could spiral out of control.

Students earn checks when they do not follow the rules (i.e., rule violation) and their conduct or social behavior grade is based on the number of rule violations. The number of rule violations assigned to a letter grade or label of performance is different depending on the grading scale in use. Rule following is indicated by the lack of checks and equals *0* and the number of rule violations ranges from “1” to “X” or a number greater than 1. Students can earn social behavior or conduct grades by subject, time periods within the day, day, or time period such as nine weeks reporting period

Students earn a letter grade (e.g., A, B, C, etc.) or label of performance (e.g., S, US, NI, Super Star, Star, Good, etc.) at the end of the day based on the total number of checks for the day.

Students earn a weekly grade by adding the total number of checks for the week and dividing by days in school for an average number of rule violations. The average number of rule violations is assigned a letter grade or level of performance based on the selected rubric.

One novel feature of this method is the evolving grading scale used for reporting social behavior progress. An example of such an evolving grading scale is indicated in the chart below.

| | | | Grading Period | | Grading Period | | Grading Period | | Grading Period | |
|---|---|---|---|---|---|---|---|---|---|---|
| Grading | | | 1 | | 2 | | 3 | | 4 | |
| Rubrics | | | R1 | R2 | R3 | R4 | R5 | R6 | R7 | R8 |
| Weeks | Pre K/K | Grades 1 + | 1-4 | 5-9 | 10-13 | 14-18 | 19-22 | 23-27 | 28-31 | 32-36 |

RED

| | | | | | | | | | | |
|---|---|---|---|---|---|---|---|---|---|---|
| (about 75% of class | Super | A | 0-4 | 0-4 | 0-4 | 0-3 | 0-3 | 0-3 | 0-2 | 0-2 |
| is off task/high | Good | B | 5-7 | 5 | 5 | 4-5 | 4 | 4 | 3-4 | 3 |
| | Ok | C | 8-9 | 6-7 | 6-7 | 6 | 5 | 5 | 5 | 4 |
| | Yikes | D | 10 | 8 | 8 | 7 | 6 | 6 | 6 | 5 |
| | | F | 11+ | 9+ | 9+ | 8+ | 7+ | 7+ | 7+ | 6 |

In this example the school year of 36 weeks is divided into four grading periods in which there are eight different grading scales (R1-R8). In Grading Period 1 the same grading scale R1 is utilized for weeks 1-4; however for weeks 5-9 grading scale R2 is utilized wherein it becomes more difficult (must have fewer demerits or checks) to earn a B or C and more difficult to avoid earning a D or F. As the school year progresses the grading standard is progressively raised. However, the grading scale needs to be consistent at least across the week and should not change in the middle of a week.

The grading scales can be determined for the school year by weeks and by grading period. Preferably, a scale change would occur when 85% to 95% of students are earning weekly grades of either an A or B or an average of A or B for a minimum of 3 weeks. Another way to change scales is to assign a rubric to a time period (e.g., Weeks 1-4, Weeks 5-9, etc.) and then if by the end of the time period, 85% to 95% of students are earning an A or B, then change to the next scale. Both ways are appropriate and depend on student behavior data for decision making.

When it is time to change to the next level of grading scale, students need to know the details such as the number of rule violations they can make and still earn an “A” or one of the other letter grades, as well as the day the new scale will begin. It is important for students to know that the reason the scale will change is because their past behavior is indicating they are ready for the next level of expectation in terms of social behavior. In other words, most students should be fluent rule followers and earning good grades.

Several grading scales may be used in a reporting period and therefore the grade must be figured differently if more than one grading scale is used during the reporting period. The focus is on quality grading points assigned to each letter grade and not absolute number of checks. Notice the difference in the number of rule violation between R1 and R2 grading in the example provided above.

In this example, if a student “Bill” earned an average of 6 demerits or checks for weeks 1-4, then using the R1 scale the student would have earned a B for that time period. If “Bill” also earned an average of 6 checks during weeks 5-9, then using the R2 scale he would have earned a C. Thus, to obtain a grade for Grading Period 1 that includes both the R1 and R2 grading scales, the following steps are used:

1. First, assign the number of quality points to the grade. The following assignment would be typical:

| | |
|---|---|
| If grade for time period is ″A″ | then A = 4 quality points |
| If grade for time period is ″B″ | then B = 3 quality points |
| If grade for time period is ″C″ | then C = 2 quality points |
| If grade for time period is ″D″ | then D = 1 quality points |
| If grade for time period is ″F″ | then F = 0 quality points |

2. Second, add the quality points in the R1 grading scale time period and get a total for the R1 time period.

3. Finally, divide the total for the R1 time period by the number of weeks in R1.

4. Use the average from step 3 and the grading scale for R1 to determine the letter grade from the above chart for R1

5. The letter grade from step 4 is then compared to the quality points chart above to determine the quality points earned for that period.

This procedure is repeated for each scaling period (R1 and R2) in the Grading Period 1. The results of these calculations for “Bill” in the example set forth in the chart below are shown.

| | | total | | | | Quality |
|---|---|---|---|---|---|---|
| | week | checks | days | avg | grade | Pts |
| R1 | | | | | | |
| Bill | 1 | 20 | 5 | 4 | A | |
| Bill | 2 | 33 | 4 | 8.25 | C | |
| Bill | 3 | 25 | 5 | 5 | B | |
| Bill | 4 | 17 | 5 | 3.4 | A | |
| totals | | 95 | 19 | 5 | | |
| | | | | B | | 3 |
| R2 | | | | | | |
| Bill | 5 | 15 | 5 | 3 | A | |
| Bill | 6 | 28 | 5 | 5.6 | B+ | |
| Bill | 7 | 28 | 4 | 7 | C | |
| Bill | 8 | 10 | 5 | 2 | A | |
| Bill | 9 | 12 | 5 | 2.4 | A | |

| | | | |
|---|---|---|---|
| totals | 93 | 24 | 3.875 |

| | |
|---|---|
| B+ | 3 |

The one component of the plan that remains constant is adding the total number of checks by day and across time. Below is an example of a students' progress during the first 9 weeks of school. The student earned A's, B's, and C's during weeks 1-9. His rule violating behavior decreased from week 2-5 and then increased for 2 weeks; however, it did not exceed the highest number of rule violations (i.e., 33) observed in week 2. By week 8, the student's number of rule violations decreased once again. This scenario is normal for most students if the program is implemented with fidelity.

The following chart provides an example of a reinforcement and penalty plan for a particular time period (e.g., 60 minutes, 2 hours, 3 hours):

| No. of | |
|---|---|
| Demerits | Reinforcement or Penalty earned |
| 0-1 | Student receives a “ [symbol] ” sticker |
| 2-3 | Student does not receive a sticker, but receives words of |
| | encouragement |
| 4 | Student does not receive a sticker, but receives words of |
| | encouragement |
| 5 | Student receives a copy of the rules and must write the |
| | violated rule of conduct before the end of the day |
| 6 | Student attends behavior class during a recess period and must |
| | write the rules of conduct and describe the right way to behave |
| 7 | Student receives a 10 minute “time out” in back of class |
| | room and must write “stop and think” sentences |
| 8 | Student receives a form with the number of rules |
| | violated that mujst be signed by a parent and returned |
| | to the school the next day |

The Plan may also include a more extreme punishment for particularly disruptive behavior. For example, if a student rule violates more than 8 times during a scheduled time period, they will earn an “F” for the day or an office referral.

Progress Monitoring. Once the plan is developed and students are trained, their progress should be monitored frequently and continuously. This is necessary if social behavioral performance is expected to match a set of teacher determined classroom expectations. It is likely that some students make more mistakes or violations than others. To see student performance, data should be plotted and analyzed for any changes. Watching these data allows more accurate next steps to be determined. A line graph or frequency polygon is a common format for the display of data. Line graphs are typically used to progress monitor or track student behavior. The number of violations is plotted daily and changes can be observed daily, weekly, or at any specified point in time. The following is an example of a graph that monitors the number of daily violations for a student.

Behavior Class. The conceptual framework for learning basic compliance requires training students to become fluent in rule following. Listening and following teacher directions is essential for learning to take place in the classroom. Some students come to school with rule following behavior in their behavioral repertoire and others may come with either performance or skill deficit in rule following. Therefore, for students to be considered socially competent in school, they must learn to engage in rule following behaviors.

For students to become successful rule followers, they need to know the rules and how to perform them. With the method of this invention, there are two parts to the training that are necessary to maintain and increase rates of child compliance: 1) teachers need to clearly describe the program components such that students understand and can follow the program; and 2) there must be practice opportunities with performance feedback. Both parts are dependent on the teacher being able to successfully implement the components systematically, consistently and with integrity.

Behavior class is a formal class designed to teach and reinforce rule following in students across school years. Because the method is a behavioral program that includes observable and measurable behaviors and consequences and the measurement of rule following, it may takes some time for both teacher and student to become fluent in both implementation and learning. The goal is to incorporate the program components in a routine manner across school years; it is not meant to be an add-on classroom management plan that is introduced the first week of school and then forgotten.

During behavior classes, students are taught the rules and the consequences and are provided practice time until they understand and can imitate the expectation. Behavior classes are similar to reading and math classes in that the teacher should ensure that all students know what they supposed to do. When students know the behaviors expected of them, they have no excuse for noncompliance. Behavior classes also hold students accountable when they do not follow the rules as instructed. A logical consequence for not following the rules is requiring practice during times that are inconvenient for the student (e.g., during recess, free time, etc.).

Behavior classes should be scheduled daily and occur at the start of the school day. This is reasonable because teaching expected behaviors will save class time in the long run. However, if students do not use the skills they have been taught, then practice should occur during students' free time. If students use up content time with play, then playtime should be used for review and practice of the social behaviors. Not only will this review and practice reinforce skill use, but it will also help students connect problem behaviors with consequences. The ultimate goal is to have basic rule following become routine. Compliance should be automatic and unnoticed by students and teachers.

During the first day and first week of school, behavior classes will require longer teaching time to ensure all components are taught. Teaching and describing each component includes telling, modeling, and practice. After the initial week of training and practice, students will need ongoing support to achieve “A” and “B” behavior because the expectations will change and earning an “A” may be more challenging for some.

The initial behavior class may require up to two hours to completely describe the program. During the remainder of the first week, behavior classes should range in time from twenty minutes to an hour to practice and discuss the rules and consequences depending on student rule following behavior. During the second week, behavior classes may range from five to twenty minutes depending on whether a new skill is introduced (e.g., using eye contact while asking a question) or students continue to practice skills they are have difficulty displaying.

Behavior classes are most effective when they are routine, systematic, and ongoing, just like any other class. It is most important to build good behavioral habits early in the school year. In fact, making a concerted effort to teach routine skills during the first grading period will ensure they become automatic and will increase academic learning time. In addition to being taught early in the school year, behavior classes should be taught regularly. A time should be scheduled each day for behavior classes, just as core subjects. Some teachers incorporate behavior classes into a morning class meeting. The advantage of this time slot is that it can be used extensively for behavior classes early in the year and can be used for other school needs as the year progresses.

Material is taught in behavior classes through a five-step process: (1) telling students the skill to be learned, (2) showing students how the skill should and should not be performed, (3) having students do the skill, (4) having students practice the skill, and (5) monitoring and re-teaching the skill. The first three steps constitute the formal classroom lesson. Practice opportunities should be frequent at first and embedded in the normal classroom routines. During the monitor and re-teach phase, students are expected to perform the skill correctly. If students don't use the skill correctly, they should participate in re-teaching sessions as needed.

In the initial behavior class, first gain student attention, and then introduce the topic. It is also important to provide a rationale for why the skill is important.

Show the class exactly how the skill is to be performed. Often it is helpful to have students assist with the demonstration. Include both “right way- wrong way” examples. In other words, show students what to do and what not to do. Avoid gray areas, which are vague and open to interpretation. Explain that there are correct ways to do the task and that there are incorrect ways to do the task.

Doing or practicing the new behavior provides an opportunity for the entire class to perform the skill. It is preferred that at least five opportunities are provided for the class to perform the skill during the introductory lesson. Student behavior should be closely monitored during their performance, and feedback provided about correct and incorrect performance. It is preferred that positive feedback is provided during this monitoring which will continue to reinforce the right way to engage in the skill Attention of the teacher and that of the students should be directed toward those who are making improvements to further aid in building the appropriate skills.

The basic premise of the method is that student social behavior should steadily improve. As student behavior meets expectations, then it is preferred that expectations should be raised for rule following and teaching pro-social skills. In this context it can be desirable for the student to have easy and ready access to that student's history in learning correct social behavior in a classroom environment. Thus, assembling the collected data for a student in a format that effectively conveys that student's progress in learning and using the rules of conduct for correct social behavior in a classroom environment, and in a manner that can be provided to the student is highly desirable. One method to provide the desired information to a student is through the teacher inputting the data (e.g., demerits earned during given periods and the social behavior grades earned during those given periods) into a data base program that can provide tables, graphs and/or charts indicating the progress and status of the student in learning and using the correct social behavior in a classroom environment. The student can be provided limited access to the data base to receive this information regarding that student's performance over time.

The data collected by the teacher can be utilized not only in teaching a student proper social behavior in a classroom environment, but can also be used in evaluating the performance of the teacher, a school or a school district. The type of reports in evaluating a student's performance includes graphs of total demerits recorded by a teacher during a class period, during a day, during a week or during longer periods, such as a grade reporting period or a school year. Similar graphs can be generated to evaluate a teacher. In those graphs the total demerits of all students recorded by teacher would be graphed against the time period selected. In evaluating a school the total demerits of all students recorded by all teachers in that school would be graphed against the time period selected. If desired graphs can be generated that reflect the performance of a student or a teacher over a selected time period against the performance of all students or against the performance of all teachers, respectively. Still further graphs can be generated that reflect the total amount of demerits awarded by one teacher or all teachers in a school for violation of a particular rule of conduct over a selected time period to assist in evaluating where emphasis may need to be placed. Other comparative data graphs can be created from the fields of data collected.

The use of a handheld computer device in recording the student social behavior observations is preferred. It is preferred that student rule violating behavior is recorded using a handheld or tablet computer that utilizes a web based application to process and print the desired type of report.

What I claim is:

1. A method for teaching social behavior to students comprising the steps of:
(a) identifying rules of conduct,
(b) establishing positive consequences for obeying the rules of conduct and establishing negative consequences for disobeying the rules of conduct,
(c) teaching the students the rules of conduct and the consequences for obeying and disobeying the rules of conduct,
(d) tracking and recording on a periodic basis the conduct of students in disobeying the rules of conduct,
(e) establishing a grading scale and assigning to the students a grade based on their conduct and the grading scale,
(f) monitoring over time the changes to the grade,
(g) conducting behavior class for the students, and
(h) re-evaluating the grading scale based on the grade made by the students over time.

2. The method according to claim 1 wherein the rules of conduct comprise: (a) follow teacher directions, (b) keep hands, feet and objects to oneself, (c) raise hand for teacher attention or to talk, and (d) stay in assigned area using appropriate body behavior.

3. The method according to claim 1 wherein the each of the rules of conduct observable by a teacher in a classroom environment and recordable by a teacher in a classroom environment.

4. The method according to claim 1 wherein the grading system varies over time.
